(19) United States
(12) Patent Application Publication
(10) Pub. No.: US 2026/0135783 A1
(43) Pub. Date: May 14, 2026

(54) TECHNIQUES FOR GENERATING A COMPOSITE SERVICE LEVEL INDICATOR (SLI)

(71) Applicant: NOBL9 INC., Waltham, MA (US)

(72) Inventors: Alexander Lucas Hidalgo, Brooklyn, NY (US); Jakub Gruszecki, Sulechów (PL)

(21) Appl. No.: 18/947,818

(22) Filed: Nov. 14, 2024

(51) Int. Cl. H04L 41/5019; H04L 41/5009

(52) U.S. Cl. CPC H04L 41/5019; H04L 41/5016

(57) ABSTRACT

A method includes: (a) receiving, by a computer, reliability data from a plurality of remote reporting devices representing reliability of a plurality of subsystems of a technological system, each subsystem having at least one pre-set SLO; (b) for each of a plurality of time periods, determining a respective SLI for each SLO; (c) for each period, determining a composite SLI of the system by averaging the SLIs for that period; (d) determining a long-term composite SLI of the system by combining the composite SLIs for all of the periods; (e) determining an impact of each subsystem on the long-term composite SLI with reference to the SLIs of that subsystem over each of the periods in comparison to the composite SLIs of the system; (f) determining which subsystem has a largest impact on the long-term composite SLI; and (g) taking remedial action on the subsystem determined to have the largest impact.

### BACKGROUND

Data services such as websites, databases, etc., provide responses to queries from users. In order to analyze how well a data service performs over time, service level indicators (SLIs) may be measured and compared to service level objectives (SLOs) set in advance. An SLI may be defined as a service threshold (e.g., successful response, response within a threshold time, etc.) and a percent adherence to that service threshold over a defined period of time. For example, one SLI may be a successful query response rate of 99% over the course of a month. Another example SLI may be a query return rate below 200 milliseconds (ms) at least 95% of the time over the course of a year.

SLOs are a popular form of measuring the reliability of software computer systems. They can measure an innumerable number of items due to their ability to understand latency, error rates, throughput, data correctness, validity, persistence, etc. Advanced adoption of SLOs also allows for the measurement of full user journeys, requiring advanced telemetry and monitoring to achieve.

### SUMMARY

Because very advanced telemetry is required to even approach full user journeys, there has long been a need to provide functionality for those who do not have a high level of sophistication. Additionally, there is a great demand for the aggregation of SLO data into more meaningful numbers that can be understood to express service performance without having to examine many different numbers.

Composite SLOs and SLIs are a novel approach to a problem that has previously not been solved. Conventionally, when trying to combine SLI data from many disparate SLIs, it is difficult to produce a reasonable output value due to the variance in the measurement type, telemetry type, data source type, as well as the interval of collection, shape of the data, and more.

The present Disclosure introduces the concept of a time-based normalization layer between a large number of SLOs with different data shapes in order to allow for them to meaningfully inform a single SLI output. That SLI output can then also be used as the input to another Composite SLI, allowing for people to build deep understandings of their systems.

In one embodiment, a method performed by a computing device is provided. The method includes: (a) receiving, by a computing device, reliability data from a plurality of reporting devices remote from the computing device, the reliability data representing reliability of a plurality of subsystems of a technological system, each subsystem having at least one pre-set SLO; (b) for each of a plurality of time periods, determining a respective service level indicator (SLI) for each SLO; (c) for each of the plurality of time periods, determining a composite SLI of the technological system by averaging the SLIs determined for that time period; (d) determining a long-term composite SLI of the technological system by combining the composite SLIs of the technological system for all of the plurality of time periods; (e) determining an impact of each subsystem on the long-term composite SLI of the technological system with reference to the SLIs of the SLO of that subsystem over each of the plurality of time periods in comparison to the composite SLIs of the technological system; (f) determining which subsystem of the plurality of subsystems has a largest impact on the long-term composite SLI of the technological system; and (g) taking remedial action on the subsystem determined to have the largest impact on the composite SLI of the technological system. A corresponding computer program product, apparatus, and system using the method are also provided.

### BRIEF DESCRIPTION OF THE DRAWINGS

The foregoing and other objects, features, and advantages will be apparent from the following description of particular embodiments, as illustrated in the accompanying drawings in which like reference characters refer to the same parts throughout the different views. The drawings are not necessarily to scale, emphasis instead being placed upon illustrating the principles of various embodiments.

FIG. 1 illustrates an example system, apparatus, and computer program product for use in connection with one or more embodiments.

FIG. 2 illustrates an example method in accordance with one or more embodiments.

FIG. 3 illustrates an example method in accordance with one or more embodiments.

### DETAILED DESCRIPTION

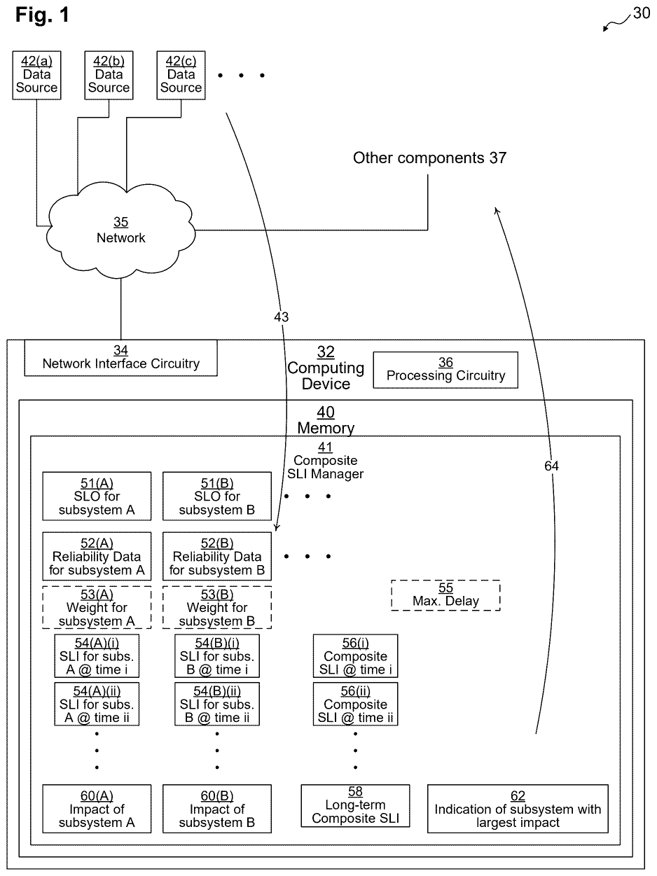

FIG. 1 depicts an example system 30 for use in connection with various embodiments. System 30 includes a computing device 32 connected to a set of data sources 42 (depicted as data sources 42(a), 42(b), 42(c), . . . ) via a network 35. System 30 also includes various other components 37, such as computers and servers configured to perform one or more tasks and/or provide one or more features.

Network 35 may be any kind of communications network or set of communications networks, such as, for example, a LAN, WAN, SAN, the Internet, a wireless communication network, a virtual network, a fabric of interconnected switches, etc.

Computing device 32 may be any kind of computing device, such as, for example, a personal computer, laptop, workstation, server, enterprise server, tablet, smartphone, etc. Computing device 32 may include processing circuitry 36, network interface circuitry 34, and memory 40. In some embodiments, computing device 32 may also include user interface (UI) circuitry for communicating with a user (not depicted). Computing device 32 may also include various additional features as is well-known in the art, such as, for example, interconnection buses, etc.

Processing circuitry 36 may include any kind of processor or set of processors configured to perform operations, such as, for example, a microprocessor, a multi-core microprocessor, a digital signal processor, a system on a chip (SoC), a collection of electronic circuits, a similar kind of controller, or any combination of the above.

Network interface circuitry 34 may include one or more Ethernet cards, cellular modems, Fibre Channel (FC) adapters, InfiniBand adapters, wireless networking adapters (e.g., Wi-Fi), and/or other devices for connecting to a network 35.

Memory 40 may include any kind of digital system memory, such as, for example, random access memory (RAM). Memory 40 stores an operating system (OS, not depicted, e.g., a Linux, UNIX, Windows, MacOS, or similar operating system) and various drivers and other applications and software modules configured to execute on processing circuitry 36 as well as various data.

Memory 40 of computing device 32 stores a composite SLI manager (CSM)41, which is configured to operate on processing circuitry 36 of computing device 32 to receive reliability data 43 from data sources 42 regarding operation of various subsystems (not depicted) of the system 30, to manage composite SLIs 56, 58 and impacts 60, to determine an indication 62 of which subsystem has the largest impact on the operation of the overall system 30, and to issue a remedial instruction 64 in response.

Memory 40 of computing device 32 also stores certain data, including SLOs 51 for each subsystem (depicted as SLOs 51(A), 51(B), . . . ), reliability data 52 for each subsystem (depicted as reliability data 52(A), 52(B), . . . ), a set of SLIs 54 for different time periods for each subsystem (depicted as SLIs 54(A) (i), 54(A) (ii), . . . for subsystem A and SLIs 54(B) (i), 54(B) (ii), . . . for subsystem B), a composite SLI 56 for each subsystem A, B, . . . (depicted as composite SLIs 56(A), 56(B), . . . ), a long-term composite SLI 58 for the system 30, an impact 60 of each subsystem A, B, . . . on the long-term composite SLI 58 for the system 30 (depicted as impacts 60(A), 60(B), . . . ), and the indication 62 of which subsystem has the largest impact on the operation of the overall system 30. In some embodiments, memory 40 also stores a weight 53 assigned to each subsystem A, B, . . . (depicted as weights 53(A), 53(B), . . . ) and/or a maximum delay 55. The weights 53 are typically pre-assigned, such as by a user.

The maximum delay 55 represents a maximum number of time periods to wait for reliability data 43 to be received for a particular subsystem before proceeding to calculate the composite SLI 56(X) for time period X. For example, if each time period is 1 minute long and the maximum delay 55 is 3 minutes, then CSM 41 waits until the end of minute X+3 to calculate the composite SLI 56(X) for time period X.

Reliability data 43 may include information about service requests of particular types performed by the other components 37. For example, the information may include whether or not each service request was fulfilled successfully and how long the fulfillment took.

Memory 40 may also store various other data structures used by the OS, SCM 41, and/or various other applications and drivers. In some embodiments, memory 40 may also include a persistent storage portion. Persistent storage portion of memory 40 may be made up of one or more persistent storage devices, such as, for example, magnetic disks, flash drives, solid-state storage drives, or other types of storage drives. Persistent storage portion of memory 40 is configured to store programs and data even while the computing device 32 is powered off. The OS, CSM 41, and/or various other applications and drivers are typically stored in this persistent storage portion of memory 40 so that they may be loaded into a system portion of memory 40 upon a system restart or as needed. The OS, CSM 41, and/or various other applications and drivers, when stored in non-transitory form either in the volatile or persistent portion of memory 40, each form a computer program product. The processing circuitry 36 running one or more applications thus forms a specialized circuit constructed and arranged to carry out the various processes described herein.

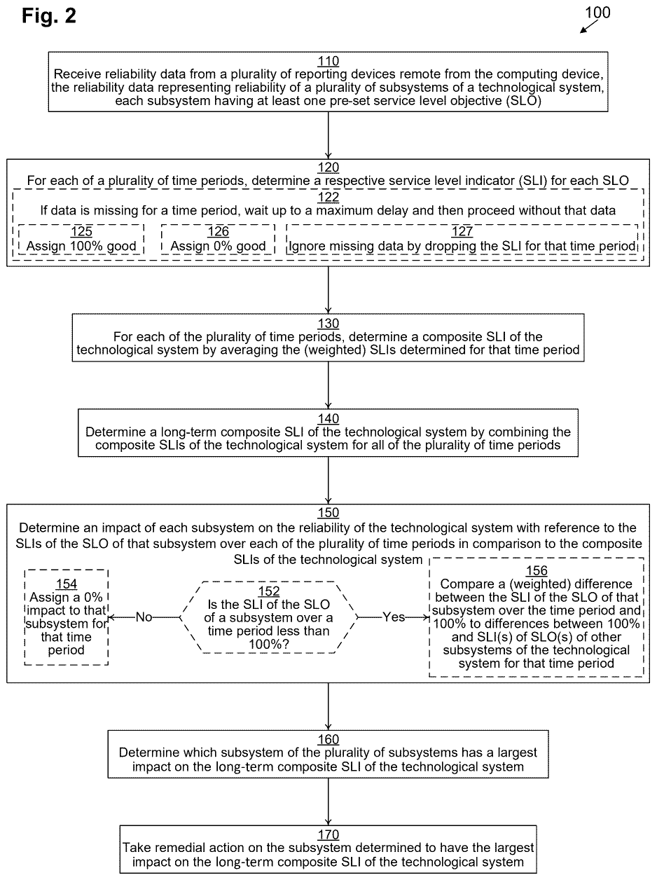

FIG. 2 illustrates an example method 100 performed by a computing device 32 for managing composite SLOs and taking appropriate actions. It should be understood that any time a piece of software (e.g., OS, CSM 41, etc.) is described as performing a method, process, step, or function, what is meant is that a computing device 32 on which that piece of software is running performs the method, process, step, or function when executing that piece of software on its processing circuitry 36. It should be understood that one or more of the steps or sub-steps of method 100 may be omitted in some embodiments. Similarly, in some embodiments, one or more steps or sub-steps may be combined together or performed in a different order. Dashed lines are indicative of optional or alternative steps or sub-steps.

In step 110, CSM 41 receives reliability data 43 from a plurality of data sources 42 remote from the computing device 32. The reliability data 43 represents the reliability of a plurality of subsystems of a technological system 30 including other components 37. Each subsystem has one or more pre-set SLOs 51. For example, a web service subsystem may have a first SLO 51(A1) representing the availability of the web service subsystem and a second SLO 51(A2) representing the latency of the web service subsystem; an e-mail service subsystem may have a third SLO 51(B1) representing the availability of the e-mail service subsystem and a fourth SLO 51(B2) representing the latency of the e-mail service subsystem; and a tape archive subsystem may have a fifth SLO 51(C1) representing the availability of the tape archive subsystem. In this example, the first SLO 51(A1) may have as its objective an availability of at least 97%, the third SLO 51(B1) may have as its objective an availability of at least 95%, and the fifth SLO 51(C1) may have as its objective an availability of at least 90%. In addition, the second SLO 51(A2) may have as its objective a latency below 300 ms at least 99% of the time, and the fourth SLO 51(B2) may have as its objective a latency below 1.5 seconds at least 92% of the time. When a subsystem includes multiple SLOs, each may be referred to as a separate “subsystem component.”

In step 120, for each of a plurality of time periods (e.g., each time period being 1 minute long), CSM 41 determines a respective SLI 54 for each SLO 51. Thus, for example, during time period 0 (e.g., minute 0:00) first SLI 54(A1) for SLO 51(A1) may be determined to be 96% in response to 96 web service requests out of 100 during that minute being successful, while third SLI 54(B1) for SLO 51(B1) may be determined to be 95% in response to 19 e-mail service requests out of 20 during that minute being successful. Then, during time period 1 (e.g., minute 0:01) first SLI 54(A1) for SLO 51(A1) may be determined to be about 98.13% in response to 105 web service requests out of 107 during that minute being successful, while third SLI 54(B1) for SLO 51(B1) may be determined to be about 82.35% in response to 14 e-mail service requests out of 17 during that minute being successful.

In some embodiments, step 120 includes sub-step 122. In sub-step 122, if reliability data 52(X) for a particular subsystem X is missing for a particular time period Y, then CSM 41 waits up to a maximum delay 55 (e.g., 3 minutes) past the end of that period Y before proceeding to step 130 for that time period Y. Depending on the embodiment, sub-step 122 may include sub-step 125, 126, or 127. In some embodiments, in sub-step 125, if reliability data 52(X) for period Y has still not been received after the maximum delay 55 has passed after the end of time period Y, then CSM 41 assigns a default SLI 54(X)(Y) of 100% for that subsystem X and time period Y. In other embodiments, in sub-step 126, if reliability data 52(X) for period Y has still not been received after the maximum delay 55 has passed after the end of time period Y, then CSM 41 assigns a default SLI 54(X)(Y) of 0% for that subsystem X and time period Y. In yet other embodiments, in sub-step 127, if reliability data 52(X) for period Y has still not been received after the maximum delay 55 has passed after the end of time period Y, then CSM 41 proceeds to ignore SLI 54(X)(Y) for that subsystem X and time period Y in step 130.

In step 130, for each of a plurality of time periods, CSM 41 determines a composite SLI 56 of the technological system 30 by averaging the SLIs 54 that were determined for that time period in step 120. In some embodiments, step 130 may be performed one time period at a time after step 120 has completed for that time period. Thus, for example, during time period Y, CSM 41 calculates composite SLI 56(Y) by averaging SLIs 54(A)(Y), 54(B)(Y), . . . . In some embodiments, step 130 may include weighting each SLI 54(X)(Y) for time period Y by the respective weight 53(X) for its subsystem X as part of the averaging operation. Thus, for example, during time period Y, CSM 41 calculates composite SLI 56(Y) by summing:
54(A)(Y)×53(A)+54(B)(Y)×53(B)+54(C)(Y)×53(C)+54(D)(Y)×53(D)+ . . . and dividing that sum by the sum of:
53(A)+53(B)+53(C)+53(D) . . . . In embodiments in which sub-step 127 was performed for a particular subsystem (e.g., subsystem C) during time period Y, then CSM 41 drops the term for that subsystem C, instead summing:
54(A)(Y)×53(A)+54(B)(Y)×53(B)+54(D)(Y)×53(D)+ . . . and dividing that sum by the sum of:
53(A)+53(B)+53(D) . . . . This is equivalent to temporarily assigning weight 53(C) to be equal to zero for the purposed of that time period Y.

In step 140, CSM 41 determines a long-term composite SLI 58 of the technological system 30 by combining the composite SLIs 56 for all of the plurality of time periods. In some embodiments, step 140 may have a time limit, only combining the composite SLIs 56 back a maximum amount of time (e.g., up to 1 hour, 1 day, 1 month, etc.). In some embodiments, this combination may be a simple average (e.g., arithmetic mean). In other embodiments, the combination may be a time-weighted mean, weighting more recent composite SLIs 56 more than less recent composite SLIs 56.

In step 150, CSM 41 determines an impact 60 of each subsystem on the reliability of the technological system 30 with reference to the SLIs 54 of that subsystem over each of the plurality of time periods under consideration (see step 140) in comparison to the composite SLIs 56. In some embodiments, step 150 may include sub-steps 152, 154, 156 for each subsystem at each time period.

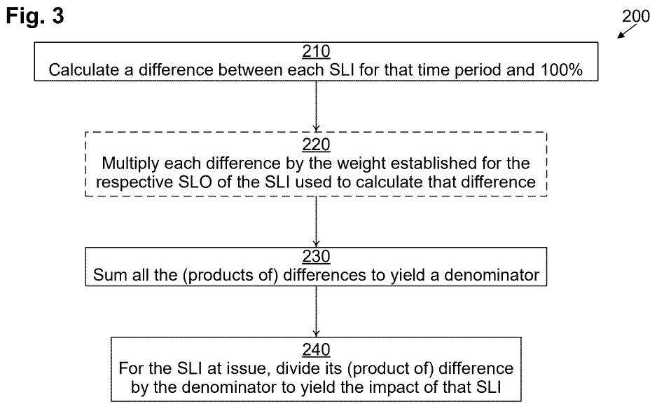

In sub-step 152, CSM 41 determines whether or not the SLI 54(X)(Y) for subsystem X at time Y is less than 100%. If not (i.e., the SLI 54(X)(Y) is 100%), then, in sub-step 154, CSM 41 assigns an impact score 60(X) (Y) for subsystem X at time Y to be 0%. Otherwise (i.e., the SLI 54(X)(Y) is less than 100%), in sub-step 156, CSM 41 compares a difference between that SLI 54(X)(Y) and 100% to the differences between the other SLIs 54(Q)(Y) and 100% at the same time period. In some embodiments, sub-step 156 may be implemented as method 200 of FIG. 3.

As depicted in FIG. 3, method 200 begins with step 210. In step 210, CSM 41 calculates a difference between each SLI 54(Q)(Y) for that time period, Y, and 100%. This may be illustrated with respect to the example of Table 1.

TABLE 1

| Subsystem | | Time Period | | | Long-term |
|---|---|---|---|---|---|
| Component | Weight | 0:01 | 0:02 | 0:03 | Composite SLI: |
| A | 1 | 90% | 75% | 100% | |
| B | 3 | 70% | 60% | 0% | |
| C | 2 | 60% | 100% | 100% | |
| | | 70% | ~75.833% | 50% | ~65.277% |

During time period 0:01, the difference for subsystem component A is 10%, the difference for subsystem component B is 30%, and the difference for subsystem component C is 40%. During time period 0:02, the difference for subsystem component A is 25%, the difference for subsystem component B is 40%, and the difference for subsystem component C is 0%. During time period 0:03, the difference for subsystem component A is 0%, the difference for subsystem component B is 100%, and the difference for subsystem component C is 0%.

In step 220, if there are weights 53 associated with the various subsystem component, then CSM 41 multiplies each difference from step 210 by its respective weight 53. With reference to the example of Table 1, during time period 0:01, the product for subsystem component A is 10%, the product for subsystem component B is 90%, and the product for subsystem component C is 80%. During time period 0:02, the product for subsystem component A is 25%, the product for subsystem component B is 120%, and the product for subsystem component C is 0%. During time period 0:03, the product for subsystem component A is 0%, the product for subsystem component B is 300%, and the product for subsystem component C is 0%.

In step 230, CSM 41 sums all the products from step 220 (or the differences from step 210 if step 220 was omitted) for a particular time period Y to yield a denominator. With reference to the example of Table 1, during time period 0:01, the denominator is 10+90+80%=180%; during time period 0:02, the denominator is 25+120+0%=145%; and during time period 0:03, the denominator is 0+300+0%=300%.

Then, in step 240, for the particular subsystem component X at issue during time period Y, CSM 41 divides the product for that X and Y from step 220 (or the difference from step 210 if step 220 was omitted) by the denominator from step 230. With reference to the example of Table 1, during time period 0:01, the impact for subsystem component A is 10/180=˜ 5.56%, the impact for subsystem component B is 90/180=50%, and the impact for subsystem component C is 80/180=˜ 44.44%. During time period 0:02, the impact for subsystem component A is 25/145=˜ 17.24%, the impact for subsystem component B is 120/145=˜82.76%, and the impact for subsystem component C is 0/145=0%. During time period 0:02, the impact for subsystem component A is 0/300=0%, the impact for subsystem component B is 300/300=100%, and the impact for subsystem component C is 0/300=0%.

Returning to step 150 in FIG. 2, once the time period specific impacts have been calculated, CSM 41 can use those to calculate the long-term impact 60 for each subsystem component, e.g., by taking the arithmetic mean over the different time periods. Thus, with reference to the example of Table 1, the long-term impact 60(A) for subsystem component A is about (5.56+17.24+0)/3=˜ 7.6%; the long-term impact 60(B) for subsystem component B is about (50+82.76)+100/3=˜ 77.59%; and the long-term impact 60(C) for subsystem component C is about (44.44+0+0)/3=˜ 14.81%.

In step 160, CSM 41 determines which subsystem component, X, has a largest impact 60(X) on the long-term composite SLI 58 of the technological system 30. With reference to the example of Table 1, subsystem component B has the largest impact 60(B) on the long-term composite SLI 58.

Finally, in step 170, CSM 41 takes remedial action on the subsystem component that was determined (in step 160) to have the largest impact 60 on the long-term composite SLI 58 of the technological system 30. The particular action taken may vary depending on the particular subsystem. For example, in the case of a web service subsystem whose latency SLO is greatly impacting the long-term composite SLI 58 of the technological system 30, step 170 may include sending a remedial instruction 64 to a set of servers configured to operate a plurality of virtual machines, the remedial instruction 64 directing the set of servers to instantiate additional virtual web servers to meet excess web service demand. Similarly, in the case of an e-mail service subsystem whose latency SLO is greatly impacting the long-term composite SLI 58 of the technological system 30, step 170 may include sending a remedial instruction 64 to the set of servers configured to operate a plurality of virtual machines, the remedial instruction 64 directing the set of servers to instantiate additional virtual e-mail servers to meet excess e-mail demand. As another example, in the case of a tape archive subsystem whose availability SLO is greatly impacting the long-term composite SLI 58 of the technological system 30, step 170 may include sending a remedial instruction 64 to a system administrator, advising the system administrator to improve the availability of the tape archive subsystem such as by performing repairs or upgrading the tape archive subsystem.

In some embodiments, it may be possible to change the SLOs 51 and/or weights 53 during operation. This may be illustrated with respect to the example of Table 2.

TABLE 2

| | | Time Period | | | | | | | |
|---|---|---|---|---|---|---|---|---|---|
| Subsystem | | | | | Subsystem | | | | |
| Component | Weight | 0:01 | 0:02 | 0:03 | Component | Weight | 0:04 | 0:05 | |
| A | 1 | 90% | 75% | 100% | A | 4 | 80% | 95% | |
| B1 | 3 | 70% | 60% | 0% | B1 | 3 | 75% | 90% | |
| C | 2 | 60% | 100% | 100% | B2 | 1 | 95% | 70% | Long-term |
| | | | | | | | | | Composite SLI: |
| | | 70% | ~75.8% | 50% | | | 80% | 90% | ~73.166% |

As depicted in Table 2, during time periods 0:01-0:03, the SLOs 51 and weights 53 are the same as in the example of Table 1, except that subsystem B is replaced with subsystem component B1. However, aftertime period 0:03, subsystem C with weight 2 is replaced with subsystem component B2 with weight 1, and the weight 53(A) of subsystem A is changed from 1 to 4. The long-term composite SLI 58 is updated to also include the new composite SLIs 56 (0:04), 56 (0:05) even though composite SLIs 56 (0:04), 56 (0:05) are calculated using different subsystem components and weights 53 than composite SLIs 56 (0:01), 56 (0:02), 56 (0:03).

During time period 0:04, the impact for subsystem component A is 80/160=50%, the impact for subsystem component B1 is 75/160=46.875%, and the impact for subsystem component B2 is 5/160=3.125%. During time period 0:05, the impact for subsystem component A is 20/80=25%, the impact for subsystem component B1 is 30/80=37.5%, and the impact for subsystem component B2 is 30/80=37.5%.

Applying step 150 to the example of Table 2, the long-term impact 60(A) for subsystem component A is about (5.56+17.24+0+50+25)/5=˜ 19.6%; the long-term impact 60(B1) for subsystem component B1 is about (50+82.76+100+46.875+37.5)/5=˜ 63.4%; and the long-term impact 60(B2) for subsystem component B2 is about (44.44+0+0+3.125+37.5)/5=˜ 17%. Applying step 160, subsystem component B1 has the largest impact 60(B1) on the long-term composite SLI 58.

The SLOs 51 and weights 53 may be edited, for example, by displaying them on a display screen to a user in a tabular format, and allowing the user to edit the SLO definitions and/or weights 53 (e.g., setting a weight 53 to zero to remove it from consideration).

In some embodiments, SLOs 51 may be layered. Thus, for example, composite SLO 51(D) may be defined as SLO 51(A1) with weight 2, plus SLO 51(B1) with weight 3, plus SLO 51(C1) with weight 1. Similarly, composite SLO 51(E) may be defined as SLO 51(A2) with weight 3, plus SLO 51(B2) with weight 4, plus SLO 51(C2) with weight 2. Then, overall composite SLO 51(G) may be defined as composite SLO 51(D) with weight 5, plus composite SLO 51(E) with weight 4, plus SLO 51(F) with weight 2. The corresponding SLIs 54, composite SLIs 56, and impacts 60 may then be calculated accordingly.

While various embodiments of the invention have been particularly shown and described, it will be understood by those skilled in the art that various changes in form and details may be made therein without departing from the spirit and scope of the invention as defined by the appended claims.

It should be understood that although various embodiments have been described as being methods, software embodying these methods is also included. Thus, one embodiment includes a tangible computer-readable medium (such as, for example, a hard disk, a floppy disk, an optical disk, computer memory, flash memory, etc.) programmed with instructions, which, when performed by a computer or a set of computers, cause one or more of the methods described in various embodiments to be performed. Another embodiment includes a computer which is programmed to perform one or more of the methods described in various embodiments.

Furthermore, it should be understood that all embodiments which have been described may be combined in all possible combinations with each other, except to the extent that such combinations have been explicitly excluded.

Finally, nothing in this Specification shall be construed as an admission of any sort. Even if a technique, method, apparatus, or other concept is specifically labeled as “background” or as “conventional,” Applicants make no admission that such technique, method, apparatus, or other concept is actually prior art under 35 U.S.C. § 102 or 103, such determination being a legal determination that depends upon many factors, not all of which are known to Applicants at this time.

What is claimed is:

1. A method comprising:
receiving, by a computing device, reliability data from a plurality of reporting devices remote from the computing device, the reliability data representing reliability of a plurality of subsystems of a technological system, each subsystem having at least one pre-set service level objective (SLO);
for each of a plurality of time periods, determining a respective service level indicator (SLI) for each SLO;
for each of the plurality of time periods, determining a composite SLI of the technological system by averaging the SLIs determined for that time period;
determining a long-term composite SLI of the technological system by combining the composite SLIs of the technological system for all of the plurality of time periods;
determining an impact of each subsystem on the long-term composite SLI of the technological system with reference to the SLIs of the SLO of that subsystem over each of the plurality of time periods in comparison to the composite SLIs of the technological system;
determining which subsystem of the plurality of subsystems has a largest impact on the long-term composite SLI of the technological system; and
taking remedial action on the subsystem determined to have the largest impact on the long-term composite SLI of the technological system.

2. The method of claim 1 wherein determining the respective SLI for each SLO includes waiting up to a maximum delay period for missing reliability data.

3. The method of claim 2 wherein determining the respective SLI for each SLO further includes, once the maximum delay period has elapsed, assigning a 100% SLI to an SLO whose data is missing for a time period.

4. The method of claim 2 wherein determining the respective SLI for each SLO further includes, once the maximum delay period has elapsed, assigning a 0% SLI to an SLO whose data is missing for a time period.

5. The method of claim 2 wherein determining the composite SLI includes, once the maximum delay period has elapsed, eliminating an SLI whose respective SLO is missing data for a time period from inclusion in the composite SLI for that time period.

6. The method of claim 1 wherein determining the impact of each subsystem on the long-term composite SLI of the technological system includes, for each time period:
assigning a 0% impact to that subsystem for that time period in response to the SLI of the SLO of that subsystem over the time period being 100%; and
in response to the SLI of the SLO of that subsystem over the time period being less than 100%, comparing a difference between the SLI of the SLO of that subsystem over the time period and 100% to differences between 100% and SLI(s) of SLO(s) of other subsystems of the technological system for that time period.

7. The method of claim 6 wherein:
averaging the SLIs determined for that time period includes weighting each SLI by a weight established for its respective SLO; and
comparing includes weighting the SLI of the SLO of that subsystem and the SLI(s) of SLO(s) of the other subsystems by the established weights for their respective SLOs.

8. A computer program product comprising a non-transitory computer-readable storage medium storing a set of instructions, which, when executed by processing circuitry of a computing device, cause the computing device to:
receive reliability data from a plurality of reporting devices remote from the computing device, the reliability data representing reliability of a plurality of subsystems of a technological system, each subsystem having at least one pre-set service level objective (SLO);
for each of a plurality of time periods, determine a respective service level indicator (SLI) for each SLO;
for each of the plurality of time periods, determine a composite SLI of the technological system by averaging the SLIs determined for that time period;
determine a long-term composite SLI of the technological system by combining the composite SLIs of the technological system for all of the plurality of time periods;
determine an impact of each subsystem on the long-term composite SLI of the technological system with reference to the SLIs of the SLO of that subsystem over each of the plurality of time periods in comparison to the composite SLIs of the technological system;
determine which subsystem of the plurality of subsystems has a largest impact on the long-term composite SLI of the technological system; and
take remedial action on the subsystem determined to have the largest impact on the long-term composite SLI of the technological system.

9. The computer program product of claim 1 wherein determining the respective SLI for each SLO includes waiting up to a maximum delay period for missing reliability data.

10. The computer program product of claim 9 wherein determining the respective SLI for each SLO further includes, once the maximum delay period has elapsed, assigning a 100% SLI to an SLO whose data is missing for a time period.

11. The computer program product of claim 9 wherein determining the respective SLI for each SLO further includes, once the maximum delay period has elapsed, assigning a 0% SLI to an SLO whose data is missing for a time period.

12. The computer program product of claim 9 wherein determining the composite SLI includes, once the maximum delay period has elapsed, eliminating an SLI whose respective SLO is missing data for a time period from inclusion in the composite SLI for that time period.

13. The computer program product of claim 8 wherein determining the impact of each subsystem on the long-term composite SLI of the technological system includes, for each time period:
assigning a 0% impact to that subsystem for that time period in response to the SLI of the SLO of that subsystem over the time period being 100%; and
in response to the SLI of the SLO of that subsystem over the time period being less than 100%, comparing a difference between the SLI of the SLO of that subsystem over the time period and 100% to differences between 100% and SLI(s) of SLO(s) of other subsystems of the technological system for that time period.

14. The computer program product of claim 13 wherein:
averaging the SLIs determined for that time period includes weighting each SLI by a weight established for its respective SLO; and
comparing includes weighting the SLI of the SLO of that subsystem and the SLI(s) of SLO(s) of the other subsystems by the established weights for their respective SLOs.

15. An apparatus comprising:
network interface circuitry connected to a network, the network interface circuitry being configured to receive reliability data from a plurality of reporting devices remote from the apparatus over the network, the reliability data representing reliability of a plurality of subsystems of a technological system, each subsystem having at least one pre-set service level objective (SLO); and
processing circuitry coupled to memory configured to:
for each of a plurality of time periods, determine a respective service level indicator (SLI) for each SLO;
for each of the plurality of time periods, determine a composite SLI of the technological system by averaging the SLIs determined for that time period;
determine a long-term composite SLI of the technological system by combining the composite SLIs of the technological system for all of the plurality of time periods;
determine an impact of each subsystem on the long-term composite SLI of the technological system with reference to the SLIs of the SLO of that subsystem over each of the plurality of time periods in comparison to the composite SLIs of the technological system;
determine which subsystem of the plurality of subsystems has a largest impact on the long-term composite SLI of the technological system; and
take remedial action on the subsystem determined to have the largest impact on the long-term composite SLI of the technological system.

16. The apparatus of claim 15 wherein determining the respective SLI for each SLO includes waiting up to a maximum delay period for missing reliability data.

17. The apparatus of claim 16 wherein determining the respective SLI for each SLO further includes, once the maximum delay period has elapsed, assigning a 100% SLI to an SLO whose data is missing for a time period.

18. The apparatus of claim 16 wherein determining the respective SLI for each SLO further includes, once the maximum delay period has elapsed, assigning a 0% SLI to an SLO whose data is missing for a time period.

19. The apparatus of claim 16 wherein determining the composite SLI includes, once the maximum delay period has elapsed, eliminating an SLI whose respective SLO is missing data for a time period from inclusion in the composite SLI for that time period.

20. The apparatus of claim 15 wherein determining the impact of each subsystem on the long-term composite SLI of the technological system includes, for each time period:
assigning a 0% impact to that subsystem for that time period in response to the SLI of the SLO of that subsystem over the time period being 100%; and
in response to the SLI of the SLO of that subsystem over the time period being less than 100%, comparing a difference between the SLI of the SLO of that subsystem over the time period and 100% to differences between 100% and SLI(s) of SLO(s) of other subsystems of the technological system for that time period.
